(19) United States
(12) Patent Application Publication
(10) Pub. No.: US 2011/0259709 A1
(43) Pub. Date: Oct. 27, 2011

(54) CONVEYOR SYSTEM FOR BOTTLES OR SIMILAR CONTAINERS

(75) Inventor: Holger Grossmann, Hamburg (DE)

(73) Assignee: KHS GmbH, Dortmund (DE)

(21) Appl. No.: 13/131,708

(22) PCT Filed: Dec. 17, 2009
(86) PCT No.: PCT/EP2009/009120

§ 371 Date: Jul. 8, 2011

(30) Foreign Application Priority Data
Feb. 9, 2009 (DE) 10 2009 008 138.0

(51) Int. Cl. B65G 33/04; B65G 37/00

(52) U.S. Cl. 198/339.1; 198/657; 198/670; 198/576

(57) ABSTRACT

The invention relates to a conveyor system for the onward conveyance of bottles or similar containers (2) from a container treatment machine, comprising at least one container guide (9) and at least one conveyor element moving the containers (2) along the container guide in a conveying direction (A), characterized in that the container guide (9) is designed for hanging guidance or neck guidance of the containers (2), and that that conveyor element provided is at least one screw conveyor (10), which can be driven by rotation about a screw axis (AS) and which is designed to interact with the upper side of the containers (2) above the container guide (9).

The invention relates to a conveyor system according to the preamble of Claim 1 or 5.

The invention relates, in particular, to a conveyor system for the onward conveying of containers from a container processing machine, for example from a filling machine, closing machine or labelling machine or from an installation that includes at least one container processing machine.

The conveyor system according to the invention forms, for example, a container outlet for the onward conveying of containers out of a sterile region or chamber of a container processing machine or installation, in which is effected the processing, i.e. for example the filling of the container with a liquid product and the subsequent closing of the containers under sterile conditions, into an adjoining chamber, for example into the environment.

Conveyor systems forming this type of container outlet are known and in general include at least one conveyor belt (outlet belt) that forms a closed loop and during the operation is driven endlessly in a rotating manner for conveying the containers in a conveying direction out of the sterile region or chamber into the adjoining region or chamber. A disadvantage here, in particular, is that the at least one conveyor belt continuously moves back into the sterile region from the outside in an unavoidable manner with its loop length being returned in opposition to the conveying direction. To avoid contamination of the sterile region, i.e. to avoid germs being dragged into the sterile region, it is consequently necessary to clean and sterilize the conveyor belt continuously, for example with highly concentrated hydrogen peroxide, e.g. with 35% hydrogen peroxide, or with peracetic acid. These types of cleaning and/or sterilizing media and in particular also their evaporating products, lead to considerable loads on the environment and ambient air, among other things having disadvantageous effects on the operating personnel. Without additional ventilation and disposal systems, in many cases it is not possible to maintain the maximum admissible load in the ambient air with an evaporated cleaning and/or sterilizing medium, which also indicates increased expenditure for the installation.

A further disadvantage is also that in many cases these types of cleaning and sterilization media are very aggressive and lead to corrosion in the region of the outlet belt in so far as the operating elements at that location are not specifically corrosion-resistant.

In order to keep the outlet belt that extends out of the sterile region into the adjoining region short and thereby to simplify the cleaning and sterilizing of said output belt, in many cases with known conveyor systems of this kind an additional conveyor belt is provided connecting to the outlet belt in the conveying direction. The outlet conveyor belt leading out of the sterile region is then accommodated in an additional housing as far as the transition to the onward conveying conveyor belt. Even this means additional expenditure at least on structural components.

In many cases it is also usual, in the case of installations where the processing of the containers is effected in a sterile chamber or region, to provide the individual containers after processing with a marking, for example by means of printing, e.g. by using at least one print head operating according to the ink-jet principle or a laser. The marking forms or contains, for example, information indicating the processing stations of the installation at which the respective container has been processed, so that error sources during processing, for example insufficient filling or faulty closing, can easily be detected and assigned to processing stations, for example for subsequent error elimination.

Since, as a rule, the systems or marking elements used for such a marking have to be positioned for structural reasons on the conveying system or outlet belt outside the sterile region, in many cases the problem arises that if containers tip over on the outlet belt it is no longer possible to assign the containers to their processing stations, such that in the extreme case, precisely whenever one single container is tipped over on the outlet belt and cannot be correctly detected or cannot be correctly assigned to processing stations, the marking has to be completely synchronized anew and the entire remaining batch has to be marked as “faulty”.

The unwanted tipping over of containers at the outlet out of the sterile region is also promoted by the fact that an overpressure prevails in the sterile region and there is a high air speed in the lock caused by the escaping air current, such that, above all, empty containers (bottles), which are moved out of the installation for laboratory tests, for example, as well as filled or only part-filled containers frequently tip over in particular inside said lock, but not only there, which then also results in blockages at the container outlet and leads to the installation coming to a standstill.

In addition, conveyor systems are known which in general form the container outlet of container processing machines, for example of filling machines, closing machines or labelling machines. Said conveyor systems basically comprise an outlet or conveyor star, which is driven in a rotating manner about a vertical axis, by way of which conveyor star each processed container is removed from processing positions of the processing machine and is transferred to a conveyor, which then moves the containers onward in a linear conveying movement in the conveying direction. Especially during the transfer from the circular movement in the conveyor star to the linear conveying movement on the connecting conveyor, containers above all with a relatively large container height, for example 1.5 litre bottles, tend to tip over resulting in operating faults caused by containers blocking the container outlet. In order to avoid this, in particular at the transfer between the conveyor star and the connecting conveyor, format-dependent container guide means are necessary, i.e. container guide means that are adapted to the size and/or the diameter of the processed containers and these have to be redesigned and/or replaced in the event of a format change, which represents considerable expenditure.

It is the object of the invention to provide a conveyor system which avoids the aforementioned disadvantages and which, in particular, can be used in an advantageous manner as a conveyor system for conveying containers out of a sterile region or chamber into an adjoining chamber or, generally speaking, as a container outlet at a container processing machine. This object is achieved by a conveyor system corresponding to Claim 1 or 5.

According to a first aspect of the invention, the conveyor system according to the invention forms the container outlet for conveying containers out of a sterile chamber or region into an adjoining chamber or region, for example out of a sterile chamber or region into the environment. The conveyor element moving the containers in the conveying direction is formed by at least one screw conveyor with at least one spiral, in which the containers guided in a container guide means extend by way of a portion of the container, such that the containers, with the screw conveyor driven in a rotating manner, are moved by way of said screw conveyor in a conveying direction out of the sterile chamber or region into the adjoining chamber or region. Through the use of at least one screw conveyor as conveyor element, elements of the conveyor system moving back into the sterile chamber or region are avoided, as is also, consequently, the necessity for continuous cleaning and sterilization of such elements as well as the disadvantages linked thereto.

In the case of a preferred embodiment of said conveyor system, at least the container guide means of said system is realized for suspended guiding (neck guiding) of the containers, the screw conveyor then being arranged above the container guide means such that the containers, by way of their container top end or by way of their container head or by way of their container closure provided at the container mouth, interact with the screw conveyor so as to be conveyed along the container guide means. Through the suspended arrangement of the containers at the container guide means, the tipping over in particular of empty or only part-filled containers and the disadvantages linked thereto are avoided, i.e. in particular operating malfunctions caused by tipped over containers forming blockages. In addition, the suspended guiding of the containers, secured against tipping over, makes possible trouble-free marking of the containers outside the sterile region or chamber in such a manner that said marking, generated for example by means of printing-on or by means of lasers, provides a clear reference to the processing stations of the installation accommodated in the sterile chamber, at which (processing stations) the respective container has been processed, for example filled and closed. A further advantage is that the conveyor system, without being re-equipped, in particular also without an expensive format change, can be used for differently sized containers, i.e. for containers with different container heights and/or with different container diameters and, in addition, with the screw conveyor or the at least one spiral of said screw conveyor realized in a corresponding manner, it is also possible to process containers that have clearly different diameters in the region of the container head or of the closure at that location.

According to another aspect of the invention, the conveyor system, generally speaking, forms the container outlet of a container handling machine, for example a filling machine, a closing machine, a labelling machine, etc. In the case of this embodiment of the invention, the container guide means is realized for a suspended arrangement of the container (neck guide) and at least one screw conveyor is arranged such that the containers, by way of their top end or by way of their container head or by way of their container closure provided at the container mouth, interact with the screw conveyor to be conveyed along the container guide means. This embodiment also has the advantage of reliably conveying the conveyors, secured against tipping over, and over and above this the advantage that the conveyor system, without being re-equipped, in particular also without an expensive format change, can be used for differently sized containers, i.e. for containers with different container heights and/or with different container diameters and, in addition, with the screw conveyor or the at least one spiral of said screw conveyor realized in a corresponding manner, it is also possible to process containers that have clearly different diameters in the region of the container head or of the closure at that location.

Further developments, advantages and application possibilities of the invention are produced from both the following description of exemplary embodiments and the Figures. In this case, all described and/or graphically represented features, individually or in arbitrary combination, are, in principle, objects of the invention, irrespective of their summary in the Claims or their dependency. The content of the claims is also made a component of the description.

The invention is described below by way of the Figures of an exemplary embodiment, in which, in detail:

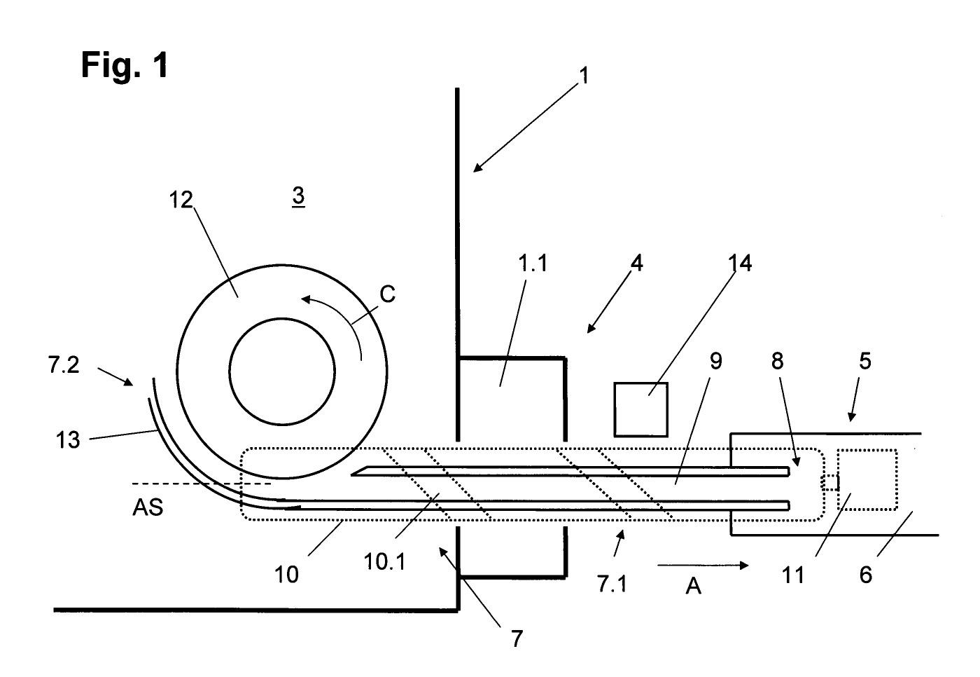

FIG. 1 shows a schematic part representation and top view of a container processing installation according to the invention, in the region of a container outlet and of a conveyor system at that location for the containers;

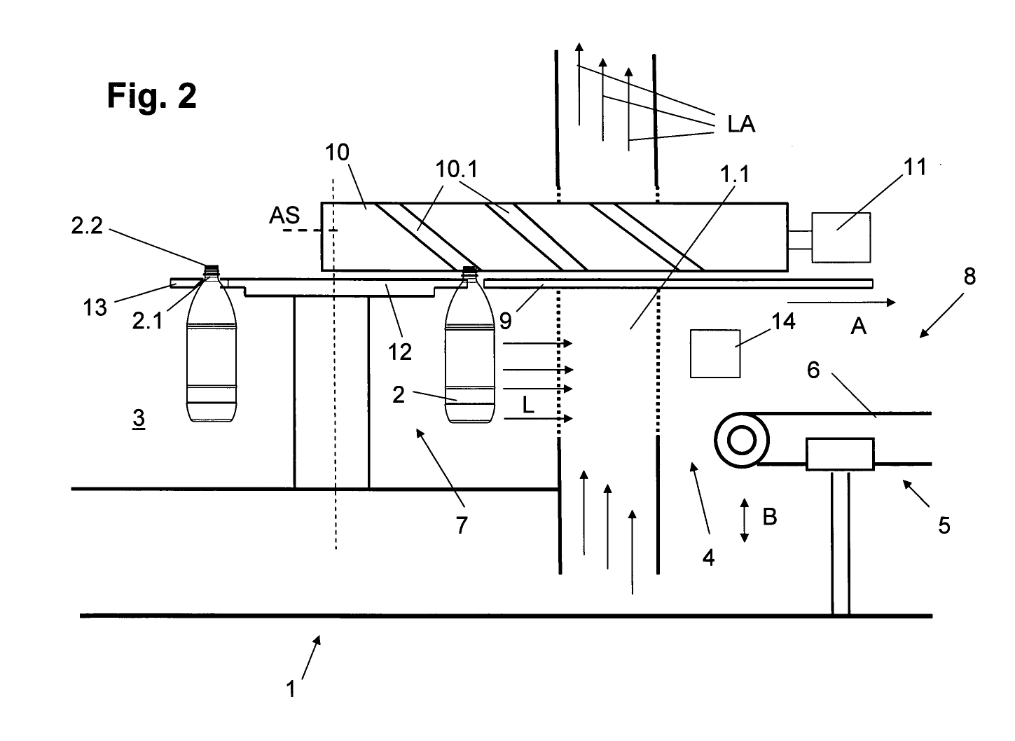

FIG. 2 shows a schematic side view of the conveyor system in FIG. 1.

In the Figures the reference 1 is given to an insulator or a housing of an installation for filling containers in the form of bottles 2 with a liquid product as well for closing the filled bottles 2, in each case under sterile conditions. For this purpose, in a known manner per se, the installation comprises at least one filling machine (not shown), arranged in the housing 1 or in the sterile interior 3 surrounded by the housing, and one closing machine (not shown either) connected downstream of said filling machine. Sterile air is supplied to the sterile interior 3 via corresponding filters such that an air overpressure is created in the interior. The achievement of said overpressure is that no non-sterile outside air can pass into the sterile interior through openings in the housing. The bottles 2 are supplied to the interior via an inlet and once filled and closed at the container outlet, given the general reference 4 in FIGS. 1 and 2, are conveyed onward to an external conveyor 5, i.e. a conveyor provided outside the housing, by way of which the bottles 2 are supplied, in the conveying direction indicated in the Figures by way of the arrow A, for more processing, for example to a machine for labelling and/or printing the bottles 2. The container outlet 4 is formed by a lock 1.1 realized in the form of an air lock. The air current leaving the interior through the overpressure is indicated by the arrows L in FIG. 2 and is sucked out upward in the region of the lock, which is represented by the arrows LA. The external conveyor 5, in the case of the embodiment represented, is formed substantially by a conveyor belt 6 that is driven in an endlessly rotating manner (e.g. a flat-top chain), which (conveyor belt), by way of its upper loop length forms a conveyor plane, on which the bottles 2, standing on their bottle bottoms and oriented with their bottle axes in the vertical direction, are moved onward in the conveying direction A.

In order to convey the bottles 2 out of the interior 3 of the housing 1 to the external conveyor 5, it is necessary to provide a conveyor system at the container output 4, said conveyor system being given the general reference 7 in the Figures, by way of which conveyor system the bottles 2 are conveyed out of the sterile interior 3 of the housing 1 as far as a transfer region 8 provided outside said housing, at which transfer region the bottles 2 are in each case transferred to the external conveyor 5 or are positioned on its conveyor belt 6. In this case it is imperative that the conveyor system 7, at least in a part region, is situated outside the sterile interior 3 of the housing 1. In order, nevertheless, to avoid dragging germs with the conveyor system 7 out of the environment outside the housing 1 into the housing 1 and consequently to avoid contamination of the interior 3, the conveyor system 7 consists, among other things, of a container guide means 9 as well as a conveyor element in the form of a screw conveyor 10 that has at least one spiral 10.1, said screw conveyor, in the case of the embodiment represented, being arranged with its screw axis AS parallel to the container guide means 9 and extending over the entire length or substantially over the entire length of the container guide means 9.

The container guide means 9 and the screw conveyor 10 extend out of the interior 3 as far as the transfer region 8 and at the same time also extend through the lock 10.1 provided at the container outlet 4.

By means of a drive 11, which is provided outside the sterile interior 3, for example at the end of the screw conveyor 10 remote from said interior, and is formed by a servomotor, the screw conveyor 10 is drivable in a rotating manner about its screw axis AS, such that the bottles 2 engaging in the spiral 10.1 of the screw conveyor 10, with the screw conveyor being driven in a rotating manner, are conveyed in the conveying direction A along the container guide means 9 out of the sterile interior 3 to the transfer region 8, without the conveyor system 7 requiring elements that move back into the sterile interior 3 during this conveying out of the environment outside the housing 1 and that continuously have to be cleaned and sterilized to avoid dragging germs into the interior 3.

In the case of the embodiment represented, the container guide means 9 is realized for suspended accommodation or guiding (neck guiding) of the bottles 2, i.e. for guiding the bottles 2 at their flange 2.1 formed in the region of the bottle mouth. The screw conveyor 10 is situated above the container guide means 9 in such a manner that the bottles 2, by way of their closed bottle head protruding upward above the container guide means 9 or by way of the bottle closure 2.2 at that location, engage in the spiral 10.1, that is to say by means of the interaction between the respective bottle closure 2.2 and the screw conveyor 10, said bottles are moved in the conveying direction A. The container guide means 9 and the screw conveyor 10 form a first section 7.1 of the conveyor system 7.

At the transfer region 8, the bottles 2 are positioned on the conveyor belt 6 by the container guide means 9. To adapt to the height of the bottles 2, the conveyor belt 6 is vertically adjustable at least at the transfer region 8, as is indicated in FIG. 2 by the double arrow B.

The conveyor system 7 also includes a conveyor star 12, which is provided in the interior 3 and is driveable in a rotating manner about a vertical axis. The conveyor star 12, by way of its circumference in cooperation with a guide rail 13 that surrounds the conveyor star 12 along a part of its circumference, forms an additional section 7.2 of the conveyor system 7, on which (section 7.2) the bottles 2 are also held suspended at their flanges 2.1 and are conveyed to the end of the section 7.1 arranged in the interior 3 or of the container guide means 9 in the direction of the arrow C. The conveyor star 12 is, for example, the outlet star of the machine for closing the bottles 2 arranged in the interior 3, such that, at the same time, the conveyor system 7 also forms the container outlet of said container processing machine.

As can be seen in particular in FIG. 1, the screw conveyor 10 overlaps the transfer region between the conveyor star 12 and the container guide means 9, such that each bottle 2 with its bottle closure 2.2 is already accommodated in the spiral 10.1 of the screw conveyor 10 before said bottle 2 passes from the conveyor star 12 into the container guide means. With the aid of the drive 11, the screw conveyor 10 is driven synchronously with the conveyor star 12, in particular also in such a manner that not only the conveying speeds of the conveyor star 12 and of the screw conveyor 10 are identical, but both conveyor elements are also driven in a precisely angled manner in such a way that the bottles 2 are transferred in a perfect manner from the conveyor star 12 to the screw conveyor 10. The zero adjustment or step angle setting of the screw conveyor 10 necessary for this is preferably executed by means of a zero offset of the servo drive 11, which means that the conveyor system 7 and at the same time in particular also the section 7.1 of said conveyor system is not format-dependent, i.e. is suitable for bottles 2 with differently sized bottle closures or differently sized diameters, and any format-dependent adjustments that may possibly be necessary can be performed in a purely electrical manner or by means of the software.

The rotational speed of the screw conveyor 10 and/or the pitch of the spiral 10.1 are preferably selected such that the relative movement of the screw with reference to the bottle leads to the closure being rotated to the right and consequently to a closing movement.

In the case of the embodiment represented, the spiral 10.1 is realized as a groove. The cross section of the spiral 10.1 is adapted to the shape of the bottles 2 at their region grasped by the screw conveyor 10. In the case of the embodiment represented, the cross section of the spiral 10.1 is accordingly adapted to the form of the bottle closures 2.2, i.e. the spiral 10.1 has, for example, a quadratic or rectangular cross section that is open towards the circumference of the screw conveyor 10. The width of the spiral 10.1 or of the groove forming said spiral 10 is at least equal to the outside diameter of the bottles 2 at their closed bottle head or at the closure 2.2 at that location. In principle, however, the width of the groove acting as spiral 10.1 can be larger than said diameter such that bottles 2 with differently sized bottle closures or with differently sized diameters can also be processed.

The pitch of the screw conveyor 10 or of the spiral 10.1 is, for example, constant over the entire length of the screw conveyor 10, such that the bottles 2 are not separated out into single bottles along the section 7.1 of the conveyor system 7. In principle, however, it is also possible to realize the screw conveyor 10 such that the pitch of the spiral 10.1 changes at least once in the conveying direction A, for example increases in order, in this manner, to change the distance between the bottles 2 following one after another in the conveying direction A.

A marking device 14 is provided at the container outlet 4, outside the housing 1 and the lock 1.1 but still in the region of the container guide means 9, by way of which marking device the bottles moved past the marking device 14 are provided with a marking by means of printing or lasing or in another suitable manner. It can then be determined from said marking, for example for quality surveillance and/or for determining error sources, at which processing position or positions of the installation arranged in the interior 3 the respective bottle 2 has been processed, for example filled and/or closed.

The advantages of the invention and in particular also the afore-described embodiment of the conveyor system are, among others: outlet belts or other conveyor elements which, during operation, continuously move out of the interior 3 into the environment and out of said environment back into the interior 3 as well as the disadvantages associated with such types of conveyor elements are avoided. In particular, it is not necessary to provide measures at the container outlet 4 for cleaning and sterilizing the conveyor element that moves the containers in the conveying direction A.

Especially on account of the neck guiding of the bottles 2, at least inside the conveyor system 7, however preferably also inside the entire arrangement accommodated in the interior 3, a secure, error-free conveying of the bottles 2 is guaranteed, without the risk of the bottles tipping over within the conveyor system 7 and ensuing operating faults that this may cause. In particular on account of the neck guiding there is no risk of full or only partly-filled bottles 2 tipping over within the air current L to the lock 1.1 and thereby causing malfunctions.

On account of the neck guiding it is also possible to mark the bottles 2 at the marking device 14 in an operationally secure manner such that a clear assignment between the bottles 2 and the processing positions of the machines arranged in the interior 3 is possible and consequently also clear, rapid recognition of possible malfunctions at individual processing stations.

On account of the neck guiding or suspended guiding of the bottles 2, the conveyor system 7 and also the machines provided in the interior 3 and further conveyor systems are also suitable for treating and processing bottles 2 or other bottle-like containers of different heights without being re-equipped or without being re-equipped in a substantial manner.

A further advantage is that the drive 11 can easily be provided outside the housing, for example in the form of a servomotor.

The invention has been described above by way of one exemplary embodiment. It is obvious that further modifications and conversions are possible without in any way departing from the inventive concept underlying the invention.

Thus it has been assumed above that the screw conveyor 10 is realized at its outside circumference in a circular cylindrical manner and consequently has a constant diameter over its entire length or substantially over its entire length. Other designs of the screw conveyor are also conceivable, for example in the form where the diameter of the screw conveyor changes at least once in the conveying direction A. In this case it is possible in particular for the container guiding means 9 to approach the transfer region 8 by lowering its conveying plane to the conveying plane of the conveyor belt 6, such that a particularly smooth, jerk-free transfer of the bottles 2 from the container guide means 9 to the conveyor belt 6 is achieved.

In addition, it has been assumed that a screw conveyor having only one spiral 10.1 is used as conveyor element for the section 7.1 of the conveyor system 7. Obviously designs are also conceivable where a screw conveyor with at least two spirals is provided in place of the screw conveyor 10.

In addition, it has been assumed that the at least one spiral 10.1 is formed by a groove. In principle, however, it is also possible to realize the at least one screw conveyor in another manner, for example in the form where on the lateral surface of a screw conveyor body, at least one screw-conveyor-type section that extends in the manner of a screw or a helix protruding beyond said lateral surface is provided, against which section the respective bottle 2 abuts, for example by way of its closed bottle head or by way of the bottle closure 2.2 at that location.

Deviating from the embodiments described in conjunction with the Figures, it is also additionally possible to arrange the at least one screw conveyor such that it does not interact with the closed bottle head of the bottles 2, but, for example, with the lateral surface or circumferential surface of said bottles 2.

In addition, it is also possible, in principle, to provide a plurality of screw conveyors acting on the bottles 2.

The invention has been described above in conjunction with an installation for treating and/or processing bottles 2. The invention is not only suitable for bottles, but also for other containers.

### LIST OF REFERENCES

1 Housing

1.1 Lock, in particular air lock

2 Bottle

2.1 Flange

2.2 Bottle closure

3 Interior

4 Container outlet

5 External conveyor

6 Conveyor belt

7 Conveyor system

7.1, 7.2 Section of the conveyor system 7

8 Transfer region

9 Container guide means

10 Screw conveyor

10.1 Spiral

11 Drive for screw conveyor 10

12 Conveyor star

13 Guide rail

14 Marking or lettering device

A Conveying direction

B Height adjustment of the conveyor belt 6

C Direction of rotation of the conveyor belt 6

L Sterile air current

LA Drawn off air current

AS Screw axis

1. An apparatus for conveying containers out of a sterile chamber of a container processing installation into an adjoining chamber, said apparatus comprising a conveyor system having
at least one conveyor element that moves the containers in a conveying direction,
wherein the at least one conveyor element includes a screw conveyor that is driveable in a rotating manner about a screw axis.

2. The apparatus of claim 1, further comprising at least one container guide means for the containers, wherein said at least one screw conveyor is provided at said container guide means.

3. The apparatus of claim 2, wherein said conveyor system is in a region of the container guide means for suspended guiding or neck guiding of the containers.

4. The apparatus of claim 2, wherein the screw conveyor is arranged above the container guide means for interaction with top ends of the containers.

5. An apparatus for conveying containers out of a container processing machine, said apparatus comprising a conveyor system having:
at least one container guide means for suspended guiding or neck guiding of said containers,
at least one conveyor element that moves the containers along the container guide means in a conveying direction,
said conveyor element having at least one screw conveyor that is driveable in a rotating manner about a screw axis, said screw conveyor being arranged above the container guide means for interaction with top ends of the containers.

6. The apparatus of claim 5, wherein the screw conveyor is arranged above the container guide means for interaction with heads or closures of the containers.

7. The apparatus of claim 5, further comprising
a conveyor star for the containers, said conveyor star being provided preceding the container guide means in the conveying direction,
wherein the conveyor star and the at least one screw conveyor are arranged and/or are driveable for a smooth transfer of the containers from the conveyor star to the at least one screw conveyor.

8. The apparatus of claim 5, further comprising at least one drive synchronized with a drive of said at least one container processing machine, for the at least one screw conveyor.

9. The apparatus of claim 5, wherein the screw conveyor comprises at least one spiral adapted to the cross section of the container heads or of the closures.

10. The apparatus of claim 5, wherein the screw conveyor comprises at least one spiral formed by a groove having a rectangular cross section.

11. The apparatus of claim 5, wherein said at least one spiral has a pitch that changes at least once.

12. The apparatus of claim 5, wherein said screw conveyor has a diameter that changes at least once along the screw axis.

13. The apparatus of claim 12, wherein the screw conveyor has a diameter that follows a changing height of said container guide means.

14. The apparatus of claim 4, wherein the screw conveyor is arranged above the container guide means for interaction with heads of closures of the container.

15. The apparatus of claim 8, wherein the at least one drive comprises a servomotor.

16. The apparatus of claim 5, wherein the screw conveyor comprises a spiral formed by a groove having a quadratic cross section.
